(19) United States
(12) Patent Application Publication
(10) Pub. No.: US 2007/0147043 A1
(43) Pub. Date: Jun. 28, 2007

(54) COOLING APPARATUS FOR A LAMP

(75) Inventors: Chia-Jui Lin, Taoyuan County (TW); Hui-Chih Lin, Taoyuan County (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: DELTA ELECTRONICS, INC., Taoyuan County (TW)

(21) Appl. No.: 11/551,119

(22) Filed: Oct. 19, 2006

(30) Foreign Application Priority Data
Dec. 28, 2005 (TW) 094147024

(51) Int. Cl. F21V 29/00

(52) U.S. Cl. 362/294; 362/373

(57) ABSTRACT

The present invention is a cooling apparatus for use in lighting that comprises a reflector. The cooling apparatus comprises an airflow guiding module and a fan wherein the guiding module is circumferentially disposed around the reflector to form a first guiding space between the reflector and the guiding module. The guiding module has an airflow inlet and an airflow outlet. The fan is disposed on the outer end of the airflow inlet to guide outside airflow traveling from the airflow inlet to the airflow outlet through the first guiding space. The cooling apparatus of the present invention further comprises a shielding device disposed on the outer end of the airflow outlet to form a second guiding space between the shielding device and the airflow outlet, whereby the reflector is cooled efficiently while shielding light.

This application claims priority based on Taiwan Patent Application No. 094147024 filed on Dec. 28, 2005.

### CROSS-REFERENCES TO RELATED APPLICATIONS

Not applicable.

### BACKGROUND OF THE INVENTION

1. Field of the Invention

The present invention relates to a cooling apparatus for a lamp, in particular, to a cooling apparatus for a projection system lamp.

2. Descriptions of the Related Art

Projectors have been frequently used as display equipments in offices, homes, and conference rooms. To prevent optical elements or other electrical components from being damaged by heat accumulation, heat generating from the light source of the projector needs to be removed efficiently. In general, a cooling apparatus for use with a projector lamp not only cools the heat generating portion of the lamp, but also assists in the cooling of the lamp cover (usually a known reflector and especially a tapered neck portion 133, which encloses a bulb disposed within the reflector). Furthermore, a shielding device 17, usually disposed between the lamp and the airflow outlet of the projector casing or other corresponding locations, prevents light leakage. However, the disposition of the shielding device 17 impedes the ventilation of the system and increases system flow resistance. This drawback clearly conflicts with the desired function of shielding light.

Specifically, as shown in FIG. 1, the cooling manner adopted in existing projection devices 1 on the market employs a fan 15 that blows towards a reflector 131 of a lamp 13. By forming a guiding channel between a casing 11 of the projector and the lamp 13, airflow is guided and blown out through an outlet 111. Before the airflow is guided through the outlet 111, the air flows through the shielding device 17 disposed on the inner side of the outlet 111.

According to the above-mentioned arrangements, the profile and location of the lamp 13 would give rise to cooling difficulties because the airflow could not travel through the side portion of the lamp 13. This side portion of the lamp 13 is the main area where heat can accumulate. High temperature accumulated in this portion (i.e. the tail of the airflow traveling around the lamp 13) influences the cooling effect of the system. Thus, it is very likely that the service life of the lamp 13 and other components in the projector are shortened, especially in the cases where projectors use lamps that require higher wattage. Furthermore, the airflow traveling around the lamp 13 goes out directly through the outlet 111 of the casing. This would cause the high temperature to locally accumulate in the outlet 111, damaging (e.g. deform or melt) the plastic casing or the shielding device disposed on the inner side of the casing. The user may also get burnt due to the exhaust air at high temperature.

Given the above limitations, an inventive cooling apparatus which (1) provides a design for efficiently cooling the reflector and neck portion of the lamp, (2) enhances the cooling capability of the system, while simultaneously guiding airflows and shielding lights, (3) prevents high temperature from accumulating in the outlet, (4) raises the usage efficiency of the fan, and (5) provides flexible placement independent of the casing of the projector, is needed in this field.

### SUMMARY OF THE INVENTION

The primary objective of this invention is to provide a cooling apparatus for a lamp. A modular design of an airflow guiding system is adapted to guide an airflow strictly traveling through a first guiding space, thereby providing an improved cooling efficiency for the reflector and neck portion of the lamp.

Another objective of this invention is to provide a cooling apparatus for a lamp. A shielding device is provided in the modular design of the airflow guiding system to form a second guiding space for guiding the airflow outward from the first guiding space through the second guiding space. The second guiding space not only complements the absence of the airflow behind the first guiding space, thereby, enhancing the cooling efficiency around the neck portion, but it also prevents the airflow guided from the first guiding space from directly heating the outlet of the casing, reducing the likelihood of local high temperature accumulating in the casing.

Still, another objective of this invention is to provide a cooling apparatus for a lamp. Disposing the shielding device onto the modular design of the airflow guiding system is adapted to simultaneously shield scattering lights of the lamp.

Yet a further objective of this invention is to provide a cooling apparatus for a lamp. The modular airflow guiding system can efficiently control the entire cost of manufacturing and assembling a projector.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view illustrating a conventional cooling apparatus of a projector;

FIG. 1B is a schematic perspective view illustrating the lamp in FIG. 1A;

FIG. 2 is an exploded view schematically illustrating a cooling apparatus of the present invention;

FIG. 3 is a schematic view illustrating a flow field of the cooling apparatus of the present invention; and

FIG. 4 is an end view of the cooling apparatus of the present invention.

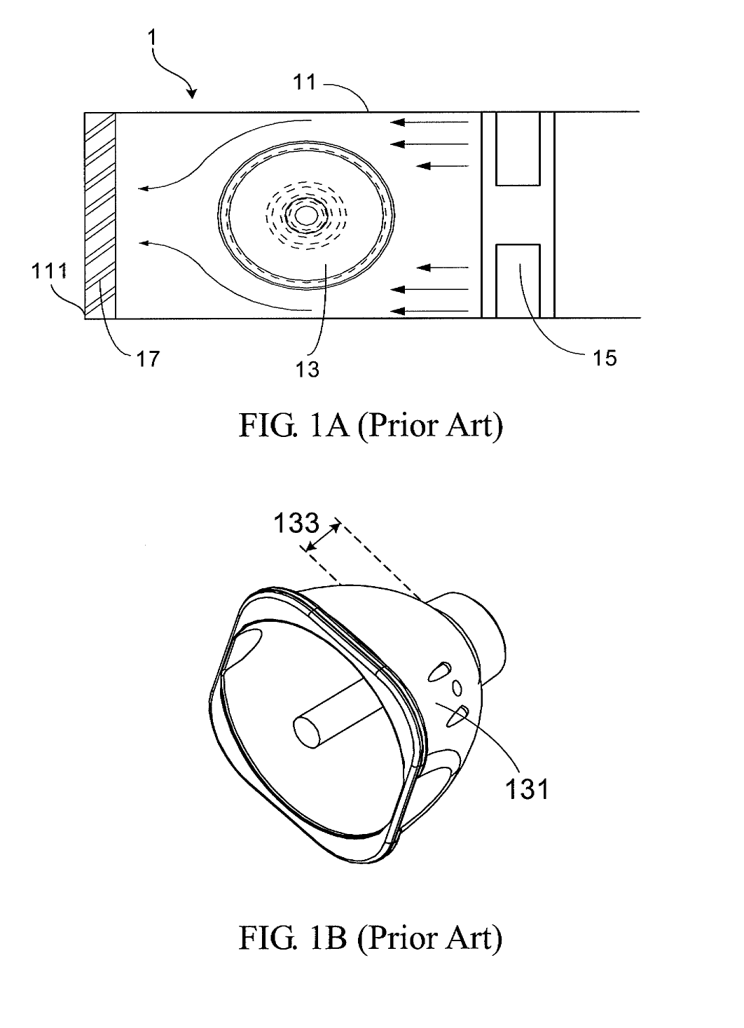

### DESCRIPTION OF THE PREFERRED EMBODIMENT

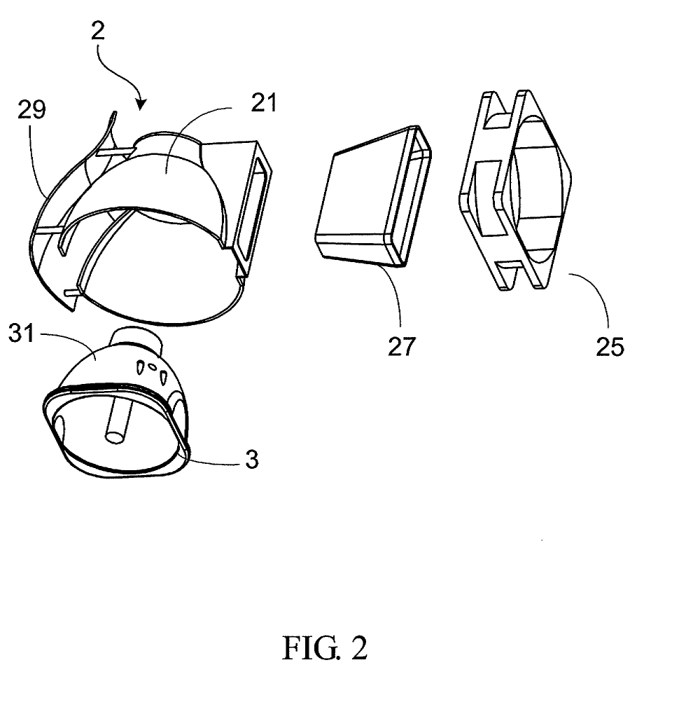

FIG. 2 is an exploded view illustrating a cooling apparatus of the present invention. A cooling apparatus 2 is used with a lamp 3. The lamp 3 comprises a cover (referred to as a reflector 31 hereinafter) and the cooling apparatus 2 includes an airflow guiding module 21 and a fan 25. Airflow generating from the fan 25 travels into the airflow guiding module 21 to cool the reflector 31 of the lamp 3.

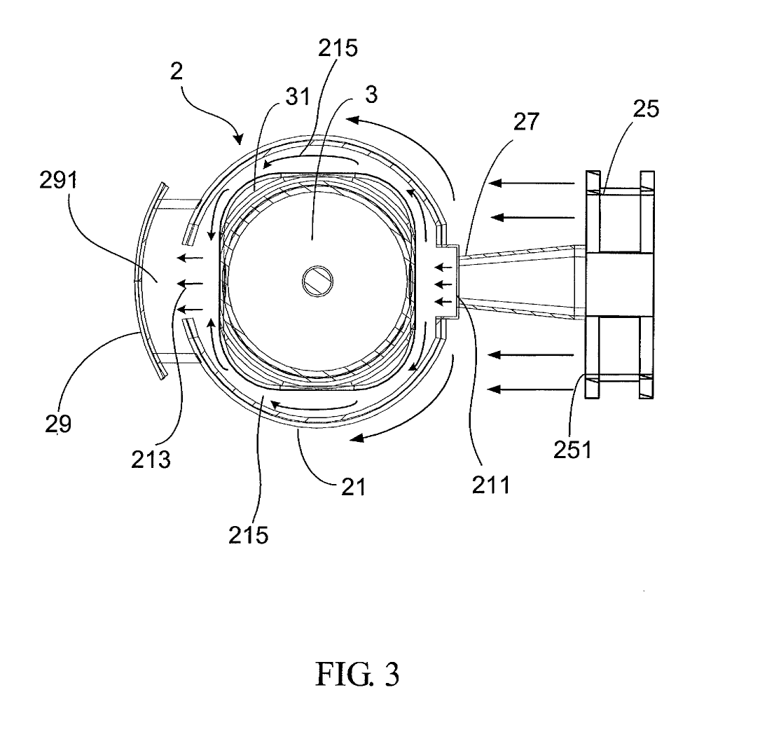

FIG. 3 illustrates the front view of a preferred embodiment of the present invention. The airflow guiding module 21 is circumferentially disposed onto the outer area of the reflector 31 of the lamp 3. The airflow guiding module 21 includes an airflow inlet end 211 and an airflow outlet end 213, forming a first guiding space 215 with the reflector 31 of the lamp 3. The fan 25 is disposed on the exterior of the airflow inlet end 211 to guide the outside airflow from the airflow inlet end 211 to the airflow outlet end 213 along the first guiding space 215.

Because the airflow guiding module 21 is circumferentially disposed along the reflector 31, the airflow can be accurately guided along the first guiding space 215 which is formed on the outer side of the reflector 31. Thus, by concentrating the flow field, all of the portions of the reflector 31, especially the neck portion where heat tends to accumulate, could be efficiently cooled. This modular design prevents not only the reflector 31, but also other precise components from being damaged as a result of the temperature exceeding the heat tolerance of the employed material.

Preferably, the apparatus further comprises an airflow guiding device 27 disposed between the fan 25 and the airflow inlet end 211. More specifically, the fan 25 comprises an outlet end 251. The airflow guiding device 27 shields at least a portion of the outlet end 251 with one of the outlet ends thereof. The other opposing outlet end of the airflow guiding device 27 connects to the airflow inlet end 211, in part or in entirety, guiding the airflow, which is generated from the fan 25, to the first guiding space 215 with a higher velocity to cool the lamp 3. In this embodiment where the airflow is partially guided into the first guiding space 215, the airflow that is not guided into the first guiding space 215 could cool the other components around the lamp 3.

More preferably, the above-mentioned embodiment further comprises a shielding device 29 disposed on the exterior of the airflow outlet end 213 of the airflow guiding module 21. The shielding device 29 is integrally formed or assembled with the airflow guiding module 21. The shielding device 29 forms a second guiding space 291 with the airflow outlet end 213, whereby the airflow traveling out of the airflow outlet end 213 flows out of the cooling apparatus 2 through the second guiding space 291. Because of the disposition of the shielding device 29, the high-temperature airflow, after traveling around the reflector 31 of the lamp 3, would not directly flow out of the casing, protecting the casing from high temperature damage. Instead, the high-temperature airflow would first run through the shielding device 29 and flow out of the airflow guiding module 21 through the second guiding space 291. There would be a buffer for high-temperature airflow to travel in a way that decreases the temperature before outflow. That is, when the airflow has a buffer to mix with cooler air, heat accumulation in the outlet of the casing could be greatly reduced.

The shielding device 29 of the present invention is designed not only for guiding the airflow, but also for providing a light shielding effect for the lamp 3. A conventional shielding board disposed on the outlet causes a higher airflow resistance, making high-temperature airflow difficult to discharge. In comparison, the shielding device 29 of the present invention is disposed adjacent to the lamp 3, thereby, shielding the blaze illuminating from the lamp 3 more effectively. As a result, an additional shielding board is not required at the outlet. Thus, the design not only reduces costs, but also reduces airflow resistance of the system. In addition, fan efficiency could be enhanced.

The above-mentioned shielding device 29 is preferably fastened (e.g. screwed or integrally formed) with the airflow guiding module 21. The airflow guiding module 21 and the shielding device 29 are preferably composed of a metallic material, or other high temperature-resistant and thermally conductive materials. In addition to reliability and durability, the use of metallic materials or thermally conductive materials simultaneously performs heat exchanges with outer cold air to facilitate cooling the airflow in the airflow guiding module 21. Furthermore, the apparatus could enhance cooling efficiency of the lamp 3.

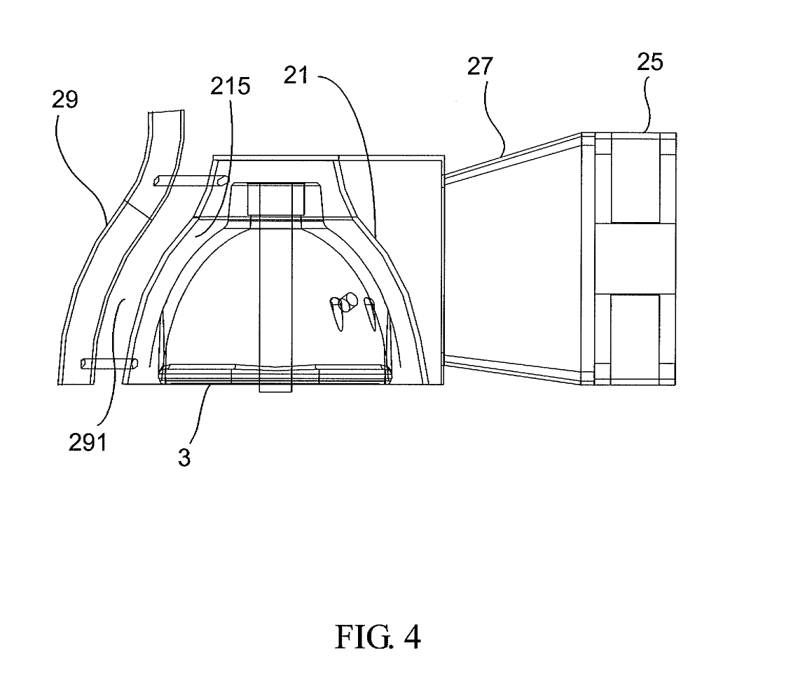

The mentioned airflow guiding module 21, as shown in FIG. 4, is substantially disposed along an outer profile of the reflector 31 of the lamp 3. The airflow guiding module 21 is disposed at a certain distance from the reflector 31, to form the mentioned first guiding space 215 and enhance performances of airflow which sweep along the reflector 31 of the lamp 3.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A cooling apparatus for a lamp, wherein the lamp comprises a cover, the cooling apparatus comprising:
an airflow guiding module, circumferentially disposed along the cover of the lamp to form a first guiding space with the cover, the airflow guiding module including an airflow inlet end and an airflow outlet end; and
a fan disposed externally of the airflow inlet end to guide an outside airflow to flow from the airflow inlet end to the airflow outlet end through the first guiding space.

2. The cooling apparatus as claimed in claim 1, wherein the airflow inlet end is formed opposing to the airflow outlet end.

3. The cooling apparatus as claimed in claim 1, further comprising an airflow guiding device disposed between the fan and the airflow inlet end.

4. The cooling apparatus as claimed in claim 3, wherein the fan comprises an outlet end and the airflow guiding device shields at least a portion of the outlet end.

5. The cooling apparatus as claimed in claim 1, wherein the airflow guiding module is composed of a high temperature resistant and thermal conductive material.

6. The cooling apparatus as claimed in claim 5, wherein the airflow guiding module is further composed of a metallic material.

7. The cooling apparatus as claimed in claim 1, further comprising a shielding device disposed externally of the airflow outlet end to form a second guiding space with the airflow outlet end, whereby the airflow running out of the airflow outlet end flows out of the cooling apparatus through the second guiding space.

8. The cooling apparatus as claimed in claim 4, further comprising a shielding device disposed externally of the airflow outlet end to form a second guiding space with the airflow outlet end, whereby the airflow running out of the airflow outlet end flows out of the cooling apparatus through the second guiding space.

9. The cooling apparatus as claimed in claim 8, wherein the shielding device is fastened to the airflow guiding module.

10. The cooling apparatus as claimed in claim 9, wherein the shielding device is screwed with the airflow guiding module.

11. The cooling apparatus as claimed in claim 9, wherein the shielding device is integrally formed with the airflow guiding module.

12. The cooling apparatus as claimed in claim 7, wherein each of the airflow guiding module and the shielding device is composed of a high temperature resistant and thermal conductive material.

13. The cooling apparatus as claimed in claim 12, wherein each of the airflow guiding module and the shielding device is further composed of a metallic material.

14. The cooling apparatus as claimed in claim 1, wherein the airflow guiding module is substantially disposed along an outer profile of the cover of the lamp.

15. The cooling apparatus as claimed in claim 1, wherein the cover is a reflector.
